(19) United States
(12) Patent Application Publication
(10) Pub. No.: US 2026/0166604 A1
(43) Pub. Date: Jun. 18, 2026

(54) METHOD AND SYSTEM FOR PYROLYTIC RECYCLING OF MOBILE PHONE CIRCUIT BOARDS

(71) Applicant: Guangzhou Aifengpai Environmental Protection Technology Co., Ltd., Guangzhou (CN)

(72) Inventors: Yulong CHEN, Guangzhou (CN); Shaohong PENG, Guangzhou (CN)

(21) Appl. No.: 19/418,330

(22) Filed: Dec. 12, 2025

(51) Int. Cl. B09B 3/40; B09B 3/35; B09B 101/17; F27B 7/02; F27B 7/14; F27B 7/20; F27B 7/38

(52) U.S. Cl. CPC B09B 3/40; B09B 3/35; F27B 7/02; F27B 7/14; F27B 7/2075; F27B 7/383; B09B 2101/17

(57) ABSTRACT

A method for pyrolytic recycling of mobile phone circuit boards is provided, in which mobile phone circuit boards are conveyed into a rotary furnace; a pyrolysis gas is caused to flow toward a feed end of the rotary furnace, and heat is exchanged with the circuit boards in a preheating section; the pyrolysis gas is directed from the feed end into a screw feeder; the pyrolysis gas is cooled, and de-oiled pyrolysis gas is discharged from the screw feeder; high-temperature flue gas is mixed with a pyrolysis gas part to form a mixed gas; the mixed gas is dedusted; a dedusted gas is cool to collect a condensed pyrolysis oil; a non-condensable residual gas is incinerated; and pyrolysis residues are discharged from a cooling section of the rotary furnace and then crushed and sieved to separate recoverable metals. A system for implementing such method is also provided.

### TECHNICAL FIELD

This application relates to waste electronic product recycling, and more particularly to a method and system for pyrolytic recycling of mobile phone circuit boards.

### BACKGROUND

Waste circuit boards, as key components of electronic waste, contain not only various heavy metals and hazardous substances such as lead, cadmium, polyvinyl chloride plastics, and brominated flame retardants that pose environmental risks, but also a variety of common and rare precious metals like copper, nickel, gold, and silver, giving them high recycling value.

With increasing environmental protection demands, the recycling and utilization of electronic waste has become a pressing issue for most countries, where the printed circuit board (PCB), as a key component in discarded household appliances, has emerged as a critical problem requiring urgent resolution for its recycling and resource recovery.

Effective treatment and resource recovery of waste circuit boards can significantly reduce the consumption of primary resources and mitigate environmental pollution, thereby playing a positive and crucial role in establishing a resource-saving and environment-friendly society and developing a circular economy.

The main treatment technologies for mobile phone circuit boards currently include pyrometallurgy, hydrometallurgy, and physical methods.

Although pyrometallurgy offers advantages of simplicity, convenience and high efficiency for extracting precious metals, it suffers from drawbacks including the generation of harmful gases from organic combustion leading to secondary pollution, low metal recovery rates, and high equipment costs.

Hydrometallurgy, as a prevalent technique for precious metal extraction from electronic waste, involves dissolving metals from waste circuit boards using acids, such as nitric acid or aqua regia, followed by their recovery from the resulting solution. Compared to pyrometallurgy, it generates less exhaust gas and produces more manageable residues after extraction, but it suffers from the generation of large volumes of wastewater that require a complex and costly treatment process, thereby posing a potential environmental threat.

Physical processing methods primarily encompass technologies such as mechanical crushing, air separation and magnetic adsorption. Currently, these methods are mainly applied to the recovery of metals like aluminum and copper. For instance, in the United States, a high-power cyclone separator is used to recover aluminum from personal computer PCBs, and by controlling the feed rate, the obtained aluminum reaches a purity of 85% with a recovery rate exceeding 90%. In Sweden, an electrostatic separator equipped with an electric drum is used to recover copper, and by optimizing operating parameters, the recovered copper achieves a grade of 93 to 99% with a recovery rate of 95 to 99%. However, these physical recycling methods entail substantial losses of precious metals and face significant challenges in the effective resource utilization of non-metallic resin powders.

The existing rotary-furnace pyrolysis processes for treating circuit boards still suffer from the following problems.

During the pyrolysis process in a rotary furnace, the continuous tumbling of pyrolysis products and the falling of pyrolysis residues from an upper section of the kiln generate a large amount of fine particulates which are difficult to settle and are readily entrained by the pyrolysis gas stream into an off-gas treatment system. As the pyrolysis gas undergoes purification and condensation, pyrolysis oil may condense and precipitate when the temperature drops, and this oil tends to adhere to the inner surfaces of equipment and pipelines, where it can capture and trap particulates from the pyrolysis gas, forming viscous oil sludge that may, over prolonged pyrolysis operation, cause blockages in pipelines and condensers.

Precious metals in mobile phone circuit boards, such as gold, are mostly present in the form of plating with a thickness generally less than 0.1 μm. During pyrolysis, they tend to form fine gold-containing ash, which can be easily entrained by the pyrolysis gas into the off-gas system and adsorbed by tar on the inner surfaces of the piping, forming oil sludge that is difficult to recover and resulting in loss. Therefore, existing rotary-kiln pyrolysis systems for circuit boards cannot achieve long-term stable operation, nor can they attain high recovery rates of precious metals such as gold and silver.

### SUMMARY

An object of the present disclosure is to provide a system and method for pyrolytic recycling of mobile phone circuit boards to overcome the defects in the prior art, including solving pipeline blockage caused by coking in existing pyrolysis gas treatment systems and improving the recovery efficiency of precious metals.

Technical solutions of the present disclosure are described as follows.

In a first aspect, this application provides a method for pyrolytic recycling of mobile phone circuit boards, including:
feeding the mobile phone circuit boards and performing pyrolysis through steps of:
continuously conveying the mobile phone circuit boards into a rotary furnace through a feeding unit; wherein the rotary furnace is configured to rotate to push the mobile phone circuit boards from a feed end toward a discharging direction, and heat the mobile phone circuit boards to a pyrolysis temperature to initiate pyrolysis, and perform pyrolysis within a residence time;
during the pyrolysis process, extracting, by an induced draft fan, pyrolysis gas from the feed end at a kiln head; and guiding the pyrolysis gas into a first feeder; wherein the first feeder is a screw feeder;
controlling an operating speed of the induced-draft fan to adjust a flow rate of the pyrolysis gas; and
discharging a pyrolysis residue from a slag-discharge port at a kiln tail into a discharge unit;
wherein a temperature of the preheating section is 400-500° C., and a temperature of the cooling section is 500-600° C.;
a temperature of each heating section is set to 600-800° C.;
the residence time of the mobile phone circuit boards in the rotary furnace is controlled to be 30-60 min;
a pyrolysis gas pressure inside the rotary furnace is controlled to be −50-0 Pa as a slightly negative pressure;
the pyrolysis residue discharged from the slag-discharge port of the rotary furnace have a temperature of 500-600° C.;
pyrolysis gas exiting from the feed end of the rotary furnace has a temperature of 400-500° C.;
the mobile phone circuit boards are delivered into the rotary furnace through a feed hopper, a second feeder and the first feeder; the feed hopper, the second feeder and the first feeder are sealed for conveying the mobile phone circuit boards; and nitrogen gas is introduced into the feed hopper to maintain a slightly positive pressure;
discharging and processing the pyrolysis residue of the mobile phone circuit boards through steps of:
feeding, through a discharge valve, the pyrolysis residue discharged from the slag-discharge port of the rotary furnace into a screw discharger;
conveying the pyrolysis residue, under propulsion of the screw discharger, into a residue storage tank;
introducing cooling water at 20-40° C. into a jacket of the screw discharger to cool the pyrolysis residue from 500-600° C. to 200-300° C.; and
supplying nitrogen gas to the residue storage tank to maintain a slight positive pressure of 0-10 kPa; and
extracting and treating pyrolysis gas of the mobile phone circuit boards through steps of:
drawing high-temperature pyrolysis gas into the first feeder from the feed end of the rotary furnace through the induced-draft fan;
introducing circulating cooling water at 20-40° C. into the jacket of the first feeder to further cool the pyrolysis gas to 200-300° C., such that a portion of the part organic vapors condenses into liquid droplets that deposit onto surfaces of the mobile phone circuit boards and are carried back into the rotary furnace together with the mobile phone circuit boards;
discharging de-oiled pyrolysis gas from an exhaust port at a middle portion of the first feeder into an induced draft splitter;
splitting, via the induced draft splitter, the de-oiled pyrolysis gas into a first pyrolysis gas part and a second pyrolysis gas part;
mixing the first pyrolysis gas part with an appropriate amount of air followed by oxygen-deficient combustion to obtain a high-temperature flue gas at 900-1200° C.;
mixing the high-temperature flue gas with the second pyrolysis gas part to form a mixed gas having a temperature of 400-600° C.;
dedusting the mixed gas, and cooling a dedusted gas in a condenser to collect a condensed pyrolysis oil;
transporting a non-condensable residual gas by a fan to an incinerator for high-temperature combustion;
purifying an incineration waste gas to meet emission standards and discharging;
wherein the oxygen-deficient combustion of the first pyrolysis gas part, in which a volume of air supplied to the burner is controlled to 70-90% of a theoretical air requirement for complete combustion of the first pyrolysis gas part, and a residual oxygen concentration in the high-temperature flue gas is controlled to less than or equal to 1%;
the mixed gas is dedusted through cyclone separation, electrostatic precipitation, bag filtration or a combination thereof;
circulating cooling water at 20-40° C. is used to cool the dedusted gas to 50° C. or below, such that the condensed pyrolysis oil is collected and the non-condensable residual gas is transported to a waste gas treatment station;
circulating cooling water at 20-40° C. is supplied to the condenser to condense the pyrolysis gas, such that the pyrolysis gas is cooled to 30-50° C., thereby causing the pyrolysis oil to condense out;
the non-condensable residual gas is subjected to combustion in the incinerator in the waste gas treatment station, such that an incineration temperature is maintained greater than or equal to 1100° C., a residence time is maintained greater than or equal to 2 s, and an incineration waste gas is purified to meet emission standards and discharged; and
the non-condensable residual gas is subjected to combustion, where an incineration temperature of the non-condensable residual gas is maintained greater than or equal to 1100° C. and a residence time is maintained greater than or equal to 2 s.

In a second aspect, this application provides a system for pyrolytic recycling of mobile phone circuit boards, including a feeding unit, a pyrolysis unit, a discharge unit, a pyrolysis gas heating unit, a dust-removal unit, a condensation unit, and an incineration unit;
wherein the feeding unit includes a feed hopper, a first feeder, a second feeder and a piping system; the second feeder is a screw feeder; an outlet at a lower end of the feed hopper is connected to an inlet of the first feeder; an outlet of the first feeder is connected to a feed inlet of the second feeder; an outlet of the second feeder is connected to a feed end of the rotary furnace; an exhaust port is provided at a middle portion of the second feeder; and the exhaust port is connected to the pyrolysis gas heating unit;
mobile phone circuit boards are fed from the outlet of the feed hopper into the second feeder through the first feeder, and are driven by the screw to enter the rotary furnace; high-temperature pyrolysis gas from the rotary furnace enters the second feeder through the outlet of the second feeder, and is brought into counter-current contact with the mobile phone circuit boards inside the second feeder; circulating cooling water at 20-40° C. is supplied into a jacket of the second feeder, whereby the pyrolysis gas is cooled to 200-300° C. inside the second feeder and then discharged through the exhaust port at the middle portion of the second feeder into the pyrolysis gas heating unit;
after the mobile phone circuit boards are charged into the feed hopper, the feed hopper is sealed with a cover plate; nitrogen gas is introduced into the feed hopper to maintain a slight positive pressure of 0-10 kPa (gauge pressure), so as to prevent the pyrolysis gas from flowing back into the feed hopper and prevent ambient air from entering the system; the nitrogen gas is mixed with the pyrolysis gas at the exhaust port at the middle portion of the second feeder, and is delivered together into the pyrolysis gas heating unit;
the pyrolysis unit includes the rotary furnace, an electric heating system and a driving motor;
a main body of the rotary furnace is inclinedly arranged, such that the feed end (head) is higher than the discharge end (tail), with an inclination angle of the rotary furnace is adjustable within a range of 0-5°;
the main body of the rotary furnace is configured to be driven to rotate by the driving motor at a speed of 2-20 r/min;
within the rotary furnace, the mobile phone circuit boards are tumbled with the rotation of the rotary furnace and moved from the head to the tail in a helical direction, while a flow direction of the pyrolysis gas is counter-current to a conveying direction of the mobile phone circuit boards;
a pyrolysis gas pressure inside the rotary furnace is controlled between −50 and 0 Pa by adjusting a rotational speed of the induced-draft fan;
a residence time of the mobile phone circuit boards in the rotary furnace is controlled between 30 and 60 min by adjusting the inclination angle and rotational speed of the rotary furnace;
the main body of the rotary furnace is externally provided with electric heating blocks; depending on the required heating temperature and control requirements, the kiln chamber is divided into six sections;
the first section is a preheating section, in which no electric heating blocks are installed, and the high-temperature pyrolysis gas generated during the pyrolysis process is used to preheat the mobile phone circuit boards, where the temperature of the preheated circuit boards is 400-500° C.;
the second to fifth sections are the heating sections, in which electric heating blocks are installed to heat the main body of the rotary furnace, and the preheated circuit boards are further heated and maintained at 600-800° C. within the heating sections;
the sixth section is a cooling section, in which no electric heating blocks are installed, and air is used to dissipate heat from the walls of the rotary furnace, the pyrolyzed circuit board residues is cooled to 500-600° C. after passing through the cooling section;
the pyrolysis gas heating unit includes an induced draft splitter, a burner and a pipe mixer; the exhaust port at the middle portion of the second feeder is connected to an inlet of the induced draft splitter; a first outlet of the induced draft splitter is connected to an inlet of the burner; an exhaust outlet of the burner is connected to a first inlet of the pipe mixer; a second outlet of the induced draft splitter is connected to a second inlet of the pipe mixer; an outlet of the gas-pipe mixer is connected to a gas inlet of the dust-removal unit; sufficient insulation layers and high-temperature steam tracing are provided on the exteriors of the pipelines and equipment to maintain the temperature of the pyrolysis gas substantially constant throughout its flow path;
the induced draft splitter is configured to split the pyrolysis gas into a first pyrolysis gas part and a second pyrolysis gas part; the first pyrolysis gas part is mixed with air and subjected to oxygen-deficient combustion in the burner at 900-1200° C., and the residual oxygen concentration in the high-temperature flue gas is controlled to be not greater than 1%; the high-temperature flue gas generated from the combustion is mixed with the second pyrolysis gas part in the pipe mixer to obtain a mixed gas, and a temperature of the mixed gas is controlled to 400-600° C.;
the dust-removal unit includes a dust collector and a dust storage tank; an inlet of the dust collector is connected to the outlet of the pipe mixer, and a gas outlet of the dust collector is connected to a gas inlet of a condenser; dust separated by the dust collector is collected in the dust storage tank; the dust collector is a cyclone separator, an electrostatic precipitator, a baghouse filter or a combination thereof; a temperature of the gas at the inlet of the dust collector is maintained greater than or equal to 400° C., and a temperature of the gas at the outlet of the dust collector is maintained greater than or equal to 300° C.; sufficient insulation layers and high-temperature steam tracing are provided on the exteriors of the pipelines and equipment to maintain the temperature of the pyrolysis gas substantially constant throughout its flow path;
the condensation unit includes a condenser, an oil storage tank and a circulating cooling water system; a gas inlet of the condenser is connected to the gas outlet of the dust collector; a gas is conveyed from a gas outlet of the condenser to the incineration unit via the induced-draft fan; circulating cooling water at 20-40° C. is introduced into a jacket of the condenser to cool the pyrolysis gas to 30-50° C.; a condensed pyrolysis oil is collected in the oil storage tank, and a non-condensable residual gas is delivered to the incineration unit;
the incineration unit includes the induced-draft fan, an incinerator and a flue-gas purifier; an inlet of the induced-draft fan is connected to the gas outlet of the condenser; and an outlet of the induced-draft fan is connected to a gas inlet of the incinerator; flue gas generated by the incineration is delivered to an inlet of the flue-gas purifier; the non-condensable residual gas from the condensation unit is mixed with air and is thoroughly combusted in the incinerator, with an incineration temperature greater than or equal to 1100° C. and a residence time greater than or equal to 2 s; and an incineration waste gas is purified to meet emission standards and then discharged;
the discharge unit includes a first discharger, a second discharger and a residue storage tank; wherein the first discharger is a rotary discharger, and the second discharger is a screw discharger;
an inlet of the first discharger is connected to a slag-discharge port at the tail end of the rotary furnace, an outlet of the first discharger is connected to an inlet of the second discharger; and an outlet of the second discharger is connected to an inlet of the residue storage tank;
pyrolysis residues discharged from the slag-discharge port of the rotary furnace are passed through the first discharger into the second discharger and are subsequently conveyed into the residue storage tank under the pushing action of the screw;
circulating cooling water at 20-40° C. is supplied to a jacket of the second discharger to cool the pyrolysis residues, such that the temperature of the cooled pyrolysis residues is controlled to 200-300° C.; and
the discharge system is configured as a sealed system, and nitrogen gas is introduced into the residue storage tank to maintain a slight positive pressure of 1-10 kPa, so as to prevent pyrolysis gas from entering the discharge system and to prevent external air from entering the discharge system; and the introduced nitrogen gas passes through the second discharger and the first discharger and then enters the rotary furnace from the slag-discharge port at the tail end, where it is mixed with the pyrolysis gas.

Compared to the prior art, the present disclosure has the following beneficial effects.

By using the system and method of the present disclosure to perform pyrolysis on mobile phone circuit boards, the circuit boards can be fully pyrolyzed and recovered without the need for prior crushing. This not only reduces the amount of dust generated during the pyrolysis process but also minimizes the loss of precious metals. Therefore, processing waste mobile phone circuit boards with the system of the present disclosure can achieve a higher recovery rate of precious metals. Compared with existing pyrolysis systems, additional advantages of the present disclosure are as follows.
1. By controlling the temperature and residence time of each heating section in the rotary furnace, thorough pyrolysis of the mobile phone circuit boards can be achieved.
2. In the present disclosure, to prevent pyrolysis oil from condensing during the dust removal process and causing pipeline blockage, the pyrolysis gas is cooled to remove oil and then heated for dust removal. The high-temperature pyrolysis gas discharged from the rotary furnace is cooled to 200-300° C. in the first feeder, i.e., screw feeder. As a result, tars in the pyrolysis gas with a boiling point above 300° C. can be effectively separated. Thereafter, maintaining the pyrolysis gas at a temperature greater than or equal to 300° C. during the dust removal process can effectively prevent the condensation of pyrolysis oil. This effectively solves the problem of coking in the dust removal and condensation pipelines that leads to blockage.
3. In the present disclosure, to heat the pyrolysis gas, high-temperature flue gas generated by the oxygen-deficient combustion of a portion of the pyrolysis gas is used to raise the temperature of the pyrolysis gas. This not only avoids the need for additional fuel, but also, by employing oxygen-deficient combustion, prevents residual oxygen, thereby ensuring system safety. Carbon monoxide formed during the oxygen-deficient combustion process can also be utilized in the subsequent pyrolysis gas combustion treatment.
4. In the present disclosure, heat generated by the combustion of a portion of the pyrolysis gas is used to raise the temperature of the pyrolysis gas. Since a portion of air is introduced, the total gas flow during the dust-removal process is increased and the gas temperature is higher, resulting in a faster gas flow, which is conducive to improving the dust-removal efficiency of the cyclone splitter.
5. In the present disclosure, to prevent outside air from entering the pyrolysis system, nitrogen gas is introduced into the feed hopper for the mobile phone circuit boards and the residue storage tank to maintain a positive pressure, which not only prevents external oxygen from entering the system, but also prevents pyrolysis gas from flowing back into the feed hopper and the residue storage tank, thereby avoiding leakage of the pyrolysis gas.

### BRIEF DESCRIPTION OF THE DRAWINGS

FIG. 1 is a flowchart of a method for pyrolytic recycling of mobile phone circuit boards according to an embodiment of the present disclosure.

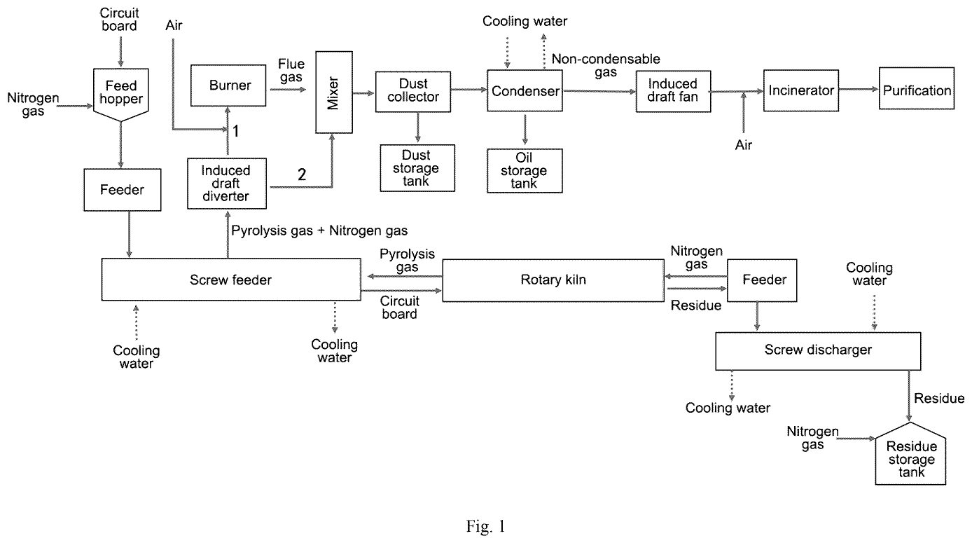

### DETAILED DESCRIPTION OF EMBODIMENTS

The objectives, technical solutions and advantages of the present disclosure will be described in detail below in conjunction with the accompanying drawings and the embodiments. It should be understood that the embodiments described herein are provided for illustrative purposes only and are not intended to limit the scope of the present disclosure. Based on the embodiments in the present disclosure, all other embodiments obtained by those of ordinary skill in the art without making creative effort shall fall within the scope of the present disclosure defined by the appended claims.

It should be noted that, terms such as “first” and “second” are only descriptive, and should not be construed as indicating or implying their relative importance or implicitly specifying the number of technical features indicated. As a result, a feature defined as “first” or “second” may include at least one of such features, either explicitly or implicitly. In addition, the technical solutions of various embodiments may be combined with each other on the premise that the combined solution can be implemented by those of ordinary skill in the art. When the combination of technical solutions appears to be contradictory or unimplementable, it should be understood that such a combination does not exist, and is not included within the scope of the present disclosure.

The dimensions and composition of mobile phone circuit boards used in the embodiments are as follows.

The waste mobile phone circuit boards for pyrolysis treatment each have dimensions of less than 10 cm×20 cm. The waste mobile phone circuit boards are analyzed using a thermogravimetric analyzer under a nitrogen atmosphere at a heating rate of 10° C./min, showing a weight loss of 36.98% at a final temperature of 800° C. After the waste mobile phone circuit boards are pulverized and dissolved to form a solution, elemental analysis shows that the waste mobile phone circuit boards contain 22.50% copper, 5.62% tin, 0.61% lead, 4.88% nickel and 0.11% gold.

### EXAMPLE 1

Operating parameters of the rotary furnace during the pyrolysis process are controlled as follows: an inclination angle of the rotary furnace is adjusted to 2°; a rotational speed of the rotary furnace is regulated to 10 r/min; a temperature of a preheating section is 400° C.; temperatures of the heating sections are all 600° C.; a temperature of a cooling section is 500° C.; and a pyrolysis gas pressure inside the rotary furnace fluctuates within a range of −40 to −10 Pa (gauge pressure).

Operating parameters of a feeding unit are as follows: a feeding rate of the mobile phone circuit boards is 200 kg/h; an inlet cooling water temperature of a screw feeder is 20° C.; at a discharge port of the screw feeder, the pyrolysis gas has a flow rate of 68 kg/h and a temperature of 400° C.; at an exhaust port located at a middle portion of the screw feeder, the pyrolysis gas has a flow rate of 54 kg/h and a temperature of 200° C.; and a nitrogen gas pressure in a feed hopper fluctuates within a range of 1 to 2 kPa (gauge pressure).

Operating parameters of a discharge unit are as follows: a residue discharged into the discharge unit has a flow rate of 139 kg/h and a temperature of 500° C.; an inlet cooling water temperature of a screw discharger is 20° C.; a temperature of the pyrolysis residue leaving the screw discharger is 200° C.; and a nitrogen gas pressure inside a residue storage tank is maintained fluctuating within a range of 1 to 2 kPa (gauge pressure).

Operating parameters of a pyrolysis gas heating unit are as follows: a volume of air supplied is 90% of a theoretical air requirement; a temperature of flue gas generated by combustion of a first pyrolysis gas is 1200° C.; an oxygen content in the combusted flue gas is 0.8%; and a temperature of gas after mixing the flue gas with a second pyrolysis gas is 600° C.

Operating parameters of a dust-removal unit are as follows: a two-stage series cyclone dust removal system is adopted; an inlet gas temperature of a cyclone separator is 600° C.; a particulate matter content in the inlet gas is 2200 mg/Nm³; an outlet gas temperature of a cyclone diverter is 550° C.; a particulate matter content in the outlet gas is 170 mg/Nm³; a dust removal efficiency is 92.27%; and an average separated dust amount is 350 g/h.

Process parameters of a condensation unit are as follows: an inlet gas temperature of a condenser is 550° C.; a temperature of a non-condensable gas at an outlet of the condenser is 40° C.; a cooling water inlet temperature is 20° C.; and a pyrolysis oil production rate is 15 kg/h.

Operating parameters of an incineration unit are as follows: an incineration temperature is 1100° C.; a residence time is 2 s; and an incineration waste gas is purified to meet emission standards and discharged.

Using a thermogravimetric analyzer, a weight-loss rate of the pyrolysis residues is measured to be 0.34%. According to the calculation method provided in the national standard “Requirements for Treatment and Disposal of Waste Printed Circuit Boards (GB/T 44157-2024)”, a pyrolysis rate of the circuit boards is calculated to be 99.08%. After determining the metal contents of the residues and the dust collected by a dust remover using an elemental analyzer, the calculated recovery rates are 99.6% for gold, 98.68% for copper, 91.69% for tin, 90.08% for lead, and 98.69% for nickel.

### EXAMPLE 2

Operating parameters of the rotary furnace during the pyrolysis process are controlled as follows: an inclination angle of the rotary furnace is adjusted to 2°; a rotational speed of the rotary furnace is regulated to 10 r/min; a temperature of a preheating section is 400° C.; temperatures of the heating sections are all 600° C.; a temperature of a cooling section is 500° C.; and a pyrolysis gas pressure inside the rotary furnace fluctuates within a range of −40 to −10 Pa (gauge pressure).

Operating parameters of a feeding unit are as follows: a feeding rate of the mobile phone circuit boards is 200 kg/h; an inlet cooling water temperature of a screw feeder is 40° C.; at a discharge port of the screw feeder, the pyrolysis gas has a flow rate of 68 kg/h and a temperature of 400° C.; at an exhaust port located at a middle portion of the screw feeder, the pyrolysis gas has a flow rate of 56 kg/h and a temperature of 300° C.; and a nitrogen gas pressure in a feed hopper fluctuates within a range of 1 to 2 kPa (gauge pressure).

Operating parameters of a discharge unit are as follows: a residue discharged into the discharge unit has a flow rate of 139 kg/h and a temperature of 500° C.; an inlet cooling water temperature of a screw discharger is 20° C.; a temperature of the pyrolysis residue leaving the screw discharger is 200° C.; and a nitrogen gas pressure inside a residue storage tank is maintained fluctuating within a range of 1 to 5 kPa (gauge pressure).

Operating parameters of a pyrolysis gas heating unit are as follows: a volume of air supplied is 70% of a theoretical air requirement; a temperature of flue gas generated by combustion of a first pyrolysis gas is 900° C.; an oxygen content in the combusted flue gas is 0.4%; and a temperature of gas after mixing the flue gas with a second pyrolysis gas is 400° C.

Operating parameters of a dust-removal unit are as follows: a baghouse filter is adopted; an inlet gas temperature of the baghouse filter is 400° C.; a particulate matter content in the inlet gas is 1900 mg/Nm³; an outlet gas temperature of the baghouse filter is 300° C.; a particulate matter content in the outlet gas is 50 mg/Nm³; a dust removal efficiency is 97%; and an average separated dust amount is 380 g/h.

Process parameters of a condensation unit are as follows: an inlet gas temperature of a condenser is 400° C.; a temperature of a non-condensable gas at an outlet of the condenser is 30° C.; a cooling water inlet temperature is 20° C.; and a pyrolysis oil production rate is 16 kg/h.

Operating parameters of an incineration unit are as follows: an incineration temperature is 1100° C.; a residence time is 2 s; and an incineration waste gas is purified to meet emission standards and discharged.

Using a thermogravimetric analyzer, a weight-loss rate of the pyrolysis residues is measured to be 0.37%. According to the calculation method provided in the national standard “Requirements for Treatment and Disposal of Waste Printed Circuit Boards (GB/T 44157-2024)”, a pyrolysis rate of the circuit boards is calculated to be 99%. After determining the metal contents of the residues and the dust collected by a dust remover using an elemental analyzer, the calculated recovery rates are 99.2% for gold, 97.29% for copper, 90.32% for tin, 90.0% for lead, and 97.29% for nickel.

### EXAMPLE 3

Operating parameters of the rotary furnace during the pyrolysis process are controlled as follows: an inclination angle of the rotary furnace is adjusted to 5°; a rotational speed of the rotary furnace is regulated to 20 r/min; a temperature of a preheating section is 500° C.; temperatures of the heating sections are all 800° C.; a temperature of a cooling section is 600° C.; and a pyrolysis gas pressure inside the rotary furnace fluctuates within a range of −30 to −10 Pa (gauge pressure).

Operating parameters of a feeding unit are as follows: a feeding rate of the mobile phone circuit boards is 200 kg/h; an inlet cooling water temperature of a screw feeder is 20° C.; at a discharge port of the screw feeder, the pyrolysis gas has a flow rate of 69 kg/h and a temperature of 500° C.; at an exhaust port located at a middle portion of the screw feeder, the pyrolysis gas has a flow rate of 57 kg/h and a temperature of 300° C.; and a nitrogen gas pressure in a feed hopper fluctuates within a range of 1 to 5 kPa (gauge pressure).

Operating parameters of a discharge unit are as follows: a residue discharged into the discharge unit has a flow rate of 137 kg/h and a temperature of 600° C.; an inlet cooling water temperature of a screw discharger is 20° C.; a temperature of the pyrolysis residue leaving the screw discharger is 300° C.; and a nitrogen gas pressure inside a residue storage tank is maintained fluctuating within a range of 1 to 6 kPa (gauge pressure).

Operating parameters of a pyrolysis gas heating unit are as follows: a volume of air supplied is 70% of a theoretical air requirement; a temperature of flue gas generated by combustion of a first pyrolysis gas is 1200° C.; an oxygen content in the combusted flue gas is 0.2%; and a temperature of gas after mixing the flue gas with a second pyrolysis gas is 600° C.

Operating parameters of a dust-removal unit are as follows: a one-stage cyclone separator connected in series with a one-stage electrostatic precipitator (i.e., a dust-removal system) is employed; an inlet gas temperature of the dust-removal system is 600° C.; a particulate matter content in the inlet gas is 2380 mg/Nm³; an outlet gas temperature of the dust-removal system is 590° C.; a particulate matter content in the outlet gas is 150 mg/Nm³; a dust removal efficiency is 93.70%; and an average separated dust amount is 362 g/h.

Process parameters of a condensation unit are as follows: an inlet gas temperature of a condenser is 590° C.; a temperature of a non-condensable gas at an outlet of the condenser is 40° C.; a cooling water inlet temperature is 20° C.; and a pyrolysis oil production rate is 18 kg/h.

Operating parameters of an incineration unit are as follows: an incineration temperature is 1100° C.; a residence time is 2 s; and an incineration waste gas is purified to meet emission standards and discharged.

Using a thermogravimetric analyzer, a weight-loss rate of the pyrolysis residues is measured to be 0.17%. According to the calculation method provided in the national standard “Requirements for Treatment and Disposal of Waste Printed Circuit Boards (GB/T 44157-2024)”, a pyrolysis rate of the circuit boards is calculated to be 99.54%. After determining the metal contents of the residues and the dust collected by a dust remover using ICP (Inductively Coupled Plasma) analysis, the calculated recovery rates are 99.5% for gold, 97.78% for copper, 90.69% for tin, 88% for lead, and 97.69% for nickel.

The effects achieved by the implementation of the present disclosure are as follows.
(1) Using the method of the present disclosure to pyrolyze waste mobile phone circuit boards yields an average of 8.35% pyrolysis oil and 69% pyrolysis residues. According to the calculation method provided in the national standard “Requirements for Treatment and Disposal of Waste Printed Circuit Boards (GB/T 44157-2024)”, the pyrolysis rate is determined using a thermogravimetric analyzer. Calculation results show that, when treated using the system and method of the present disclosure, the circuit boards exhibit a pyrolysis rate greater than 99%, indicating that the circuit boards are fully pyrolyzed. Elemental analysis further shows that the recovery rates of major metallic components such as gold, copper, nickel, lead, and tin all approach or exceed 99%.
(2) Using the method of the present disclosure, the pyrolysis gas is first cooled to remove oil and then heated for dust removal, achieving a dust removal efficiency greater than 90%. No liquid oil is observed to condense inside the dust remover, and the discharged dust is dry. After continuous operation for 30 days, the dust remover and the condenser are disassembled and inspected, showing no significant coking, with the dust layer thickness on surfaces less than 2 mm. In contrast, when the method of the present disclosure is not applied, coking layers exceeding 2 cm form in the pipeline system of the dust remover after 7 days of operation, causing dust removal efficiency to decrease from 90% to approximately 20%. The gas inlet of the condenser also exhibits coking layers of 0.5-1 cm. Therefore, the method of the present disclosure effectively prevents coking in the dust removal and condensation system, improves dust removal efficiency, and enables long-term stable operation of the pyrolysis system.

The embodiments described above are merely preferred embodiments of the present disclosure, and are not intended to limit the scope of the present disclosure. Any equivalent structural changes made based on the description and the accompanying drawings of the present disclosure under the inventive concept of the present disclosure, or direct/indirect application in other related technical fields shall fall within the scope of the present disclosure defined by the appended claims.

What is claimed is:

1. A method for pyrolytic recycling of mobile phone circuit boards based on a system, the system comprising a feed hopper, a first feeder, a second feeder, a rotary furnace, a pyrolysis gas heating unit, a condenser and a screw discharger, the second feeder being a screw feeder, the feed hopper, the first feeder and the second feeder being arranged sequentially, the rotary furnace being provided with a preheating section, a plurality of heating sections and a cooling section connected in series, the preheating section being arranged upstream of the plurality of heating sections along a conveying direction of the mobile phone circuit boards, the cooling section being arranged downstream of the plurality of heating sections along the conveying direction of the mobile phone circuit boards, the pyrolysis gas heating unit comprising an induced draft splitter, and the method comprising:
continuously conveying, via the feed hopper, the first feeder and the second feeder, the mobile phone circuit boards into the rotary furnace, wherein each of the plurality of heating sections is set to a temperature of 600-800° C., a pressure inside the rotary furnace is controlled to-50-0 Pa, and a rotational speed of the rotary furnace is controlled to 2-20 r/min;
performing pyrolysis on the mobile phone circuit boards at the plurality of heating sections of the rotary furnace with a residence time controlled to generate a pyrolysis gas and a pyrolysis residue;
transporting the pyrolysis gas in a direction opposite to the conveying direction of the mobile phone circuit boards to sequentially pass through the preheating section and the second feeder for cooling, and finally to enter the pyrolysis gas heating unit;
splitting, via the induced draft splitter, the pyrolysis gas into a first pyrolysis gas part and a second pyrolysis gas part; subjecting the first pyrolysis gas part to air-deficient combustion to generate a flue gas; mixing the flue gas with the second pyrolysis gas part to form a mixed gas having a temperature of 400-600° C.; dedusting the mixed gas, and cooling a dedusted gas to 50° C. or below in the condenser with a 20-40° C. circulating cooling water to collect a condensed pyrolysis oil; and transporting a non-condensable residual gas to a waste gas treatment station; and
discharging the pyrolysis residue from the cooling section followed by cooling to 200-300° C. via the screw discharger, crushing and sieving.

2. The method of claim 1, wherein a temperature of each of the plurality of heating sections is set to 600-800° C.

3. The method of claim 1, wherein an inclination angle of the rotary furnace is controlled to 0-5°; and the residence time of the mobile phone circuit boards in the rotary furnace is controlled by adjusting the inclination angle and the rotational speed of the rotary furnace.

4. The method of claim 1, wherein a temperature of the preheating section is 400-500° C.; and a temperature of the cooling section is 500-600° C.

5. The method of claim 1, wherein the feed hopper, the first feeder and the second feeder are sealed for conveying the mobile phone circuit boards; and nitrogen gas is supplied to the feed hopper to maintain a positive pressure.

6. The method of claim 5, wherein the pyrolysis residue discharged from the cooling section is conveyed into a residue storage tank via the screw discharger; the screw discharger is water-cooled with circulating cooling water; and nitrogen gas is supplied to the residue storage tank to maintain a positive pressure.

7. The method of claim 6, wherein the mixed gas is dedusted via a dust remover through cyclone separation, electrostatic precipitation, bag filtration or a combination thereof.

8. The method of claim 7, wherein in the waste gas treatment station, the non-condensable residual gas is subjected to combustion in an incinerator, with an incineration temperature greater than or equal to 1100° C. and a residence time greater than or equal to 2 s; and an incineration waste gas is purified to meet emission standards and discharged.

9. A system for implementing the method of claim 1, comprising:
a feeding unit;
a pyrolysis unit;
the pyrolysis gas heating unit;
a dust-removal unit;
a condensation unit;
a waste-gas treatment unit; and
a discharge unit;
wherein the feeding unit comprises the feed hopper, the first feeder and the second feeder; the second feeder is the screw feeder; and the feed hopper, the first feeder and the second feeder are configured to sealedly convey the mobile phone circuit boards to the pyrolysis unit;
the pyrolysis unit comprises the rotary furnace; the rotary furnace is provided with the plurality of heating sections arranged in series; each of the plurality of heating sections is set to 600-800° C.;
the induced-draft fan is configured to control a pyrolysis gas pressure inside the rotary furnace at-50-0 Pa by adjusting a gas-extraction rate;
the rotary furnace is inclinedly arranged, with a feed end higher than a discharge end, and an inclination angle of the rotary furnace is adjustable within a range of 0-5°;
the rotary furnace is configured to be driven by a motor to rotate at a speed of 2-20 rpm;
the preheating section is provided upstream of the plurality of heating sections; the cooling section is provided downstream of the plurality of heating sections; and the preheating section, the plurality of heating sections and the cooling section are connected in series;
the plurality of heating sections are configured to perform pyrolysis on the mobile phone circuit boards to generate the pyrolysis gas and the pyrolysis residue;
the pyrolysis gas is configured to be transported in the direction opposite to the conveying direction of the mobile phone circuit boards to pass through the preheating section and the second feeder for cooling to enter the pyrolysis gas heating unit;
the second feeder is provided with a jacket, and the jacket is configured to be supplied with the 20-40° C. circulating cooling water to cool the pyrolysis gas to 200-300° C., so as to collect condensed tars;
wherein the pyrolysis gas undergoes counter-current contact with the mobile phone circuit boards in the second feeder, and the condensed tars are captured by the mobile phone circuit boards and carried into the rotary furnace;
the pyrolysis gas heating unit comprises the induced draft splitter, a burner and a pipe mixer; the induced draft splitter is configured to split the pyrolysis gas into the first pyrolysis gas part and the second pyrolysis gas part; the burner is configured to perform oxygen-deficient combustion of the first pyrolysis gas part at 900-1200° C., wherein a volume of air supplied to the burner is controlled to 70-90% of a theoretical air requirement for complete combustion of the first pyrolysis gas part, such that a residual oxygen concentration in the flue gas is controlled to less than or equal to 1%;
the pipe mixer is configured to mixing the flue gas generated from the combustion of the first pyrolysis gas part with the second pyrolysis gas part to obtain the mixed gas having a temperature of 400-600° C.;
the dust-removal unit is configured to receive the mixed gas output from the pyrolysis gas heating unit, and dedust the mixed gas by cyclone separation, electrostatic precipitation, bag filtration or a combination thereof; a temperature at an inlet of the dust-removal unit is controlled to be greater than or equal to 400° C.; and a temperature at an outlet of the dust-removal unit is controlled to be greater than or equal to 300° C.;
the condensation unit is configured to cool the dedusted gas to 30-50° C. using circulating cooling water at 20-40° C. to collect the condensed pyrolysis oil, and to transport the non-condensable residual gas to the waste-gas treatment unit;
the waste-gas treatment unit comprises an incinerator, and the incinerator is configured to incinerate the non-condensable residual gas, wherein an incineration temperature is greater than or equal to 1100° C. and a residence time is greater than or equal to 2 s; and
the discharge unit comprises the screw discharger; and the screw discharger is configured to cool the pyrolysis residue output from the cooling section to 200-300° C. with circulating cooling water and discharge the pyrolysis residue to a residue storage tank.
